(19) United States
(12) Patent Application Publication
(10) Pub. No.: US 2003/0047085 A1
(43) Pub. Date: Mar. 13, 2003

(54) Apportioning and kneading device for dough

(76) Inventors: Eduard Rauch, St. Margarethen (AT); Peter Thomasser, Gleisdorf (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/221,515

(22) PCT Filed: Apr. 11, 2001
(86) PCT No.: PCT/AT01/00103

(51) Int. Cl. A23P 1/00; A21C 9/04

(52) U.S. Cl. 99/450.1

(57) ABSTRACT

An apparatus for portioning and kneading of dough has a drum (2) stepwisely rotatable around a horizontal axis (3) within a framework (1) by a main drive means (5) and provided on its periphery with receiving openings (4) for the dough portions to be kneaded. The dough portions are pressed-in into the receiving openings (4) at a portioning location (6) of the drum periphery by a pressing-in means (8). Further, a kneading means (23) is disposed at a kneading location (22) that is staggered with respect to the portioning location (6) in peripheral direction of the drum (2). Within each receiving opening (4) a piston (35) is moveable in radial direction of the drum (2) by a curved restricted guidance (38). The restricted guidance (38) can be rotated relative to the drum (2) by a drive means at least in the faces of stillstand of the drum motion and comprises two members (52, 53) adjustable relative to each other. The two members (52, 53) are motor-driven adjustable relative to each other by a further drive means (63) independently from the rotation of the restricted guidance (38) so that at least during the kneading process a displacement of each piston (35) positioned at the kneading location (22) takes place in radial direction of the drum (2). Thereby, an optimal adaptation to round-kneading of dough pieces is possible.

The invention relates to an apparatus for portioning and kneading of dough, comprising a drum that is stepwisely rotatable by a main drive means around a horizontal axis within a framework, which drum is provided on its periphery with receiving openings for the dough portions to be kneaded, which dough portions are introduced into the receiving openings by a pressing-in means at a portioning location of the periphery of the drum, and comprising a kneading means disposed at a kneading location that is staggered with respect to the portioning location in peripheral direction of the drum, wherein within each receiving opening a piston is displaceable in radial direction of the drum by means of a curved restricted guidance that is rotatable relative to the drum by a drive means at least in the phases of stillstand of the drum and has two members which are displaceable relative to each other.

Such an apparatus is known (AT 397 024 B). The possibility to displace the two members results in the advantage that the volume or the weight, respectively, of the dough piece that is introduced into the receiving opening at the portioning location can be changed by more or less retracting the piston within the receiving opening, without that this change has a substantial influence upon the position of the piston or, respectively, upon the motion of the piston at the kneading location.

A similar apparatus, however, having a unitary curved restricted guidance, is also known (EP 0668 016 A1), with which by a special shape of the receiving openings a substantial rectangular shape having rounded corners can be given to the dough pieces.

However, there is the desire to change the kneading pressure acting at the kneading location onto the dough piece independently from the rotation of the restricted guidance in order to improve the kneading results. This desire cannot be met by the first named known apparatus, because once the two members forming the restricted guidance have been adjusted, this adjustment remains unchanged when the restricted guidance is rotated. Within the second named known apparatus an adjustment of the restricted guidance, aside of its rotation, is altogether impossible due to the unitary construction of the structure member carrying the restricted guidance.

The invention has at its object to improve an apparatus of the initially described kind so that the kneading conditions with respect to the kneading pressure acting onto the dough piece can be changed much more as this is possible within the known apparatus, in order to enable one to better adapt to different dough volumes and/or dough qualities. The invention solves this task in that the two members are motor driven adjustable by a further drive means independently from the rotation of the restricted guidance relative to each other at least during the kneading action so that at least during the kneading action a displacement of each piston positioned at the kneading location takes place in radial direction of the drum. Thus, whereas within the known apparatus the advance motion or retracting motion of the pistons at the kneading location is only dependent from the adjusted shape of the restricted guidance, within the invention the motive effected influence of the relative adjustment of the two members superimposes to the influence of the shape of the restricted guidance. Thereby, a wide adjustment to different conditions of the dough portions to be kneaded is given for the kneading process.

The relative adjustment of the two members of the restricted guidance can be limited to the durations of the movement intervals of the stepwise drum motion, however, according to a further embodiment of the invention, the two members can be so adjusted by a further drive means already before the start of the kneading action that the pistons are moved outwardly. Thereby, the advance motion of the pistons can be so controlled—independently from the size of the dough portion to be kneaded and independently from the shape of the restricted guidance—that the dough portion to be kneaded is advanced during the advance movement of the drum already before reaching the dough location beyond the periphery of the drum, in order to obtain the so-called piston lifting. Thereby, the dough piece to be kneaded is immediately after having reached the kneading location effectively engaged by the kneading means. In a simple manner, the invention gives the possibility to change the size and the moment of this piston lifting.

The further drive means by which the relative motive displacement of the two members of the restricted guidance is made, could be derived directly kinematically from the main drive means. However, it is more favourable according to a further embodiment of the invention, when the further drive means comprises a servo motor in addition to the main drive means, which servo motor is controlled by a counting wheel rotated by the main drive means. This counting wheel gives pulses onto a control means that controls the direction of rotation and the duration of motion of the servo motor so that by the thereby effected relative adjustment of the two members of the restricted guidance, the pistons at the kneading location and/or at the portioning location and, if desired, also in the region between portioning location and kneading location are moved in the desired manner. There are no problems to construct the control means so that an adjustment possibility is given, that means that the moment of the start and/or of the end of the motion of the two members of the restricted guidance can be varied, and also the size of this adjustment.

A simple construction results within the spirit of the invention if the two members are linearly adjustable relative to each other, whereby one member is guided within a linear guide of the other member. It would be possible to make the position of both members adjustable, however, according to a preferred embodiment of the invention the construction is substantially easier if the one member is rigidly connected to a hollow shaft serving for rotation of the restricted guidance, whereas the other member carries a toothed rod meshing with a pinion disposed on a shaft bearingly supported within the hollow shaft and rotatable by the further drive means. For initiating this rotation movement, according to the invention a particular favourable construction consists in that the shaft carries a worm wheel that meshes with a worm rotatable by the further drive means. As it is known, such a worm drive means acts self-locking in the counter direction so that an undesired adjustment of the drive shaft, for example by the pressure exerted by the kneading means, is not possible.

In the drawings, the invention is schematically shown by way of an examplative embodiment.

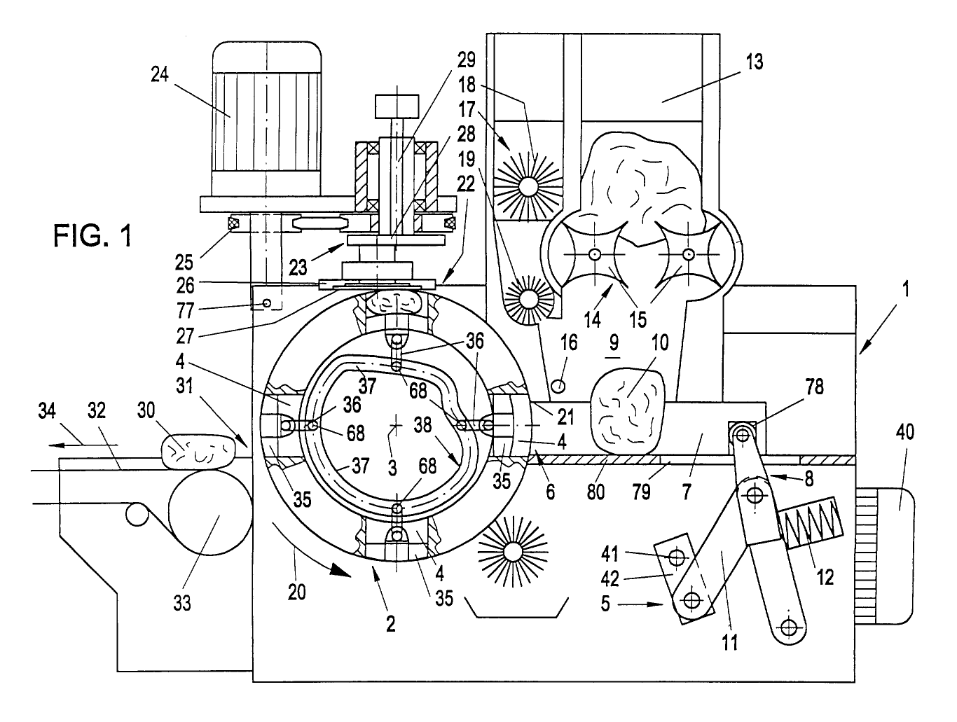

FIG. 1 shows the apparatus, partially in a vertical section.

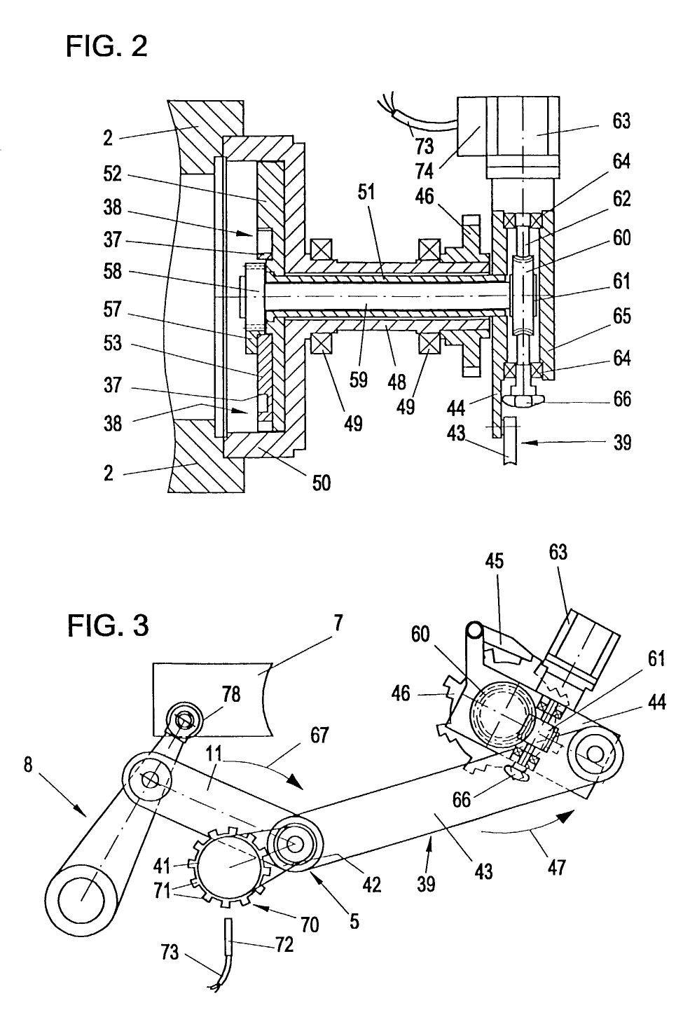

FIG. 2 shows a section through the shafts serving for rotation of the entire restricted guidance or, respectively, for the relative adjustment of the two members of the restricted guidance.

FIG. 3 shows the members serving for adjustment of the two members of the restricted guidance.

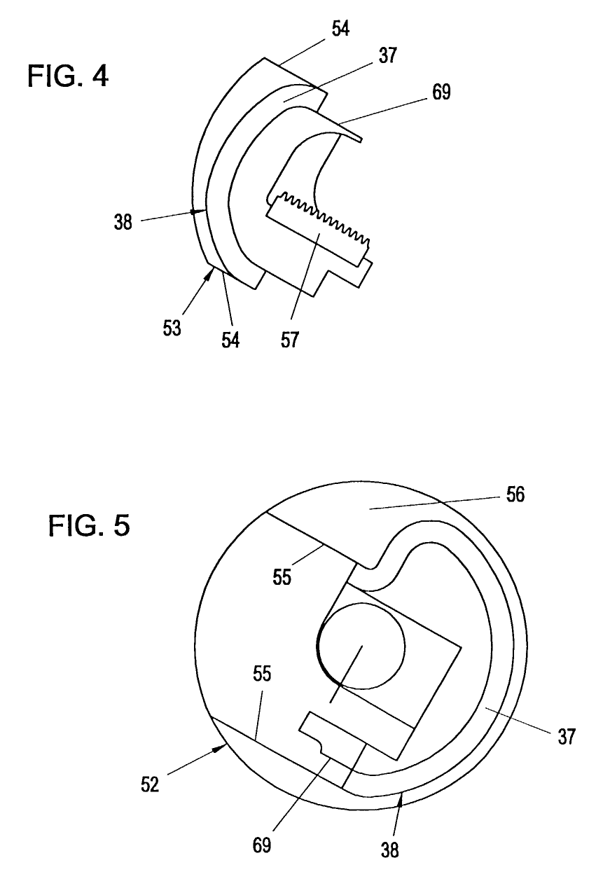

FIGS. 4 and 5 show the two members of the restricted guidance in a disengaged condition.

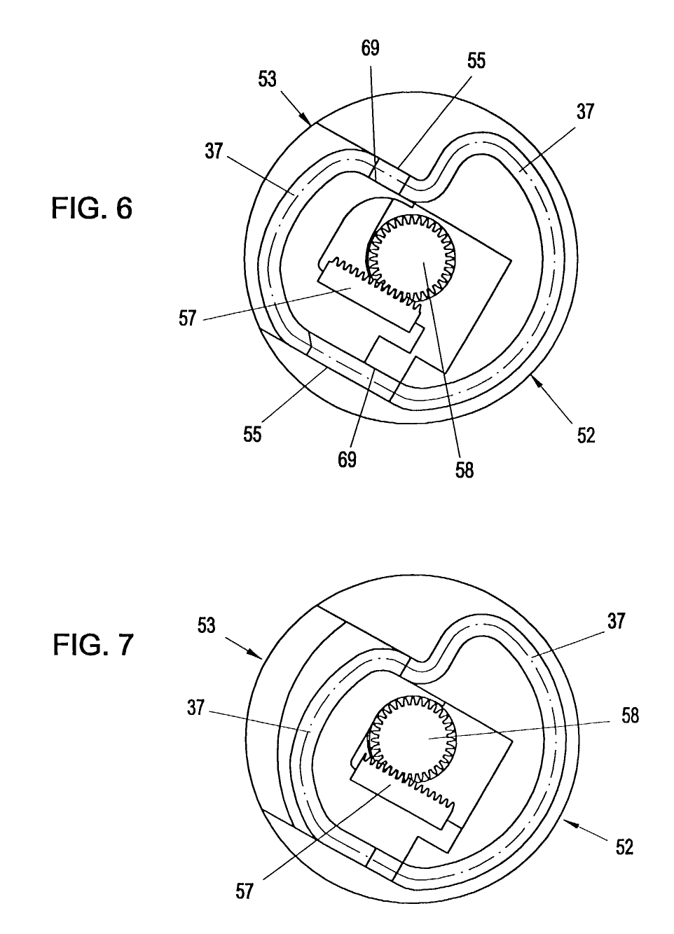

FIGS. 6 and 7 show the two members of the restricted guidance in extended or, respectively, retracted condition.

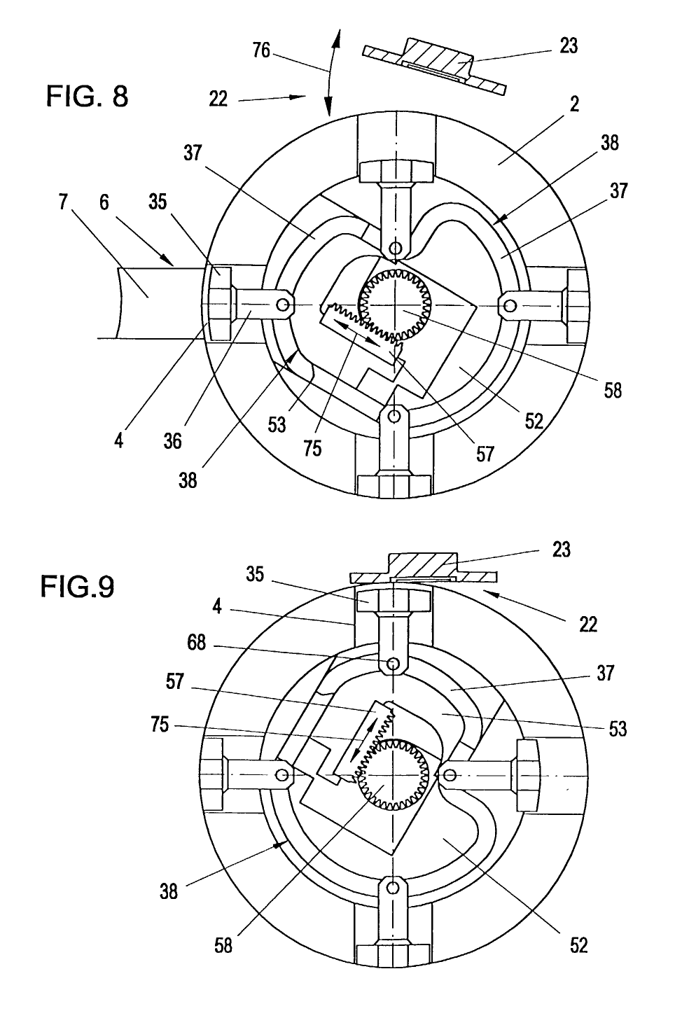

FIGS. 8 and 9 show the restricted guidance in two different phases of operation.

The apparatus comprises a framework 1 (FIG. 1), in which a drum 2 is bearingly supported for rotation around a horizontal axis 3. The drum 2 has on its periphery four rows of receiving openings 4 for the dough to be kneaded, which rows extend in axial direction, the receiving openings 4 being divided over the periphery of the drum 2 in equal distances. The drum is stepwisely driven by a main drive means 5 (FIGS. 1, 3) always in the same direction. Thereby always a row of receiving openings 4 reaches a portioning location 6 at which the dough 10 is pressed into the receiving openings 4 by means of a pressing-in means 8. The pressing-in means 8 comprises a slide 7 that is supported for displacement in horizontal direction within a chamber 9 of the framework 1 and is moved to and fro by a crank mechanism 11 driven by the main drive means 5. A spring 12 is inserted into this crank mechanism 11 and avoids that the dough 10 is too much squeezed when the gate 7 advances. The dough 10 reaches the chamber 9 from a filling shaft 13 by means of a pre-portioning means 14 that comprises two star rollers 15 rotating in counter direction around horizontal axes, which star rollers are intermittently driven in dependence from the volume of the dough 10 within the chamber 9. This volume is controlled by a sensor 16 that is actuated by the displaced dough 10 when the slide 7 is advanced, and thereby emits a pulse. When the volume of dough within the chamber 9 is too small, the pulse created by the sensor 16 is omitted, so that dough is delivered into the chamber 9 by the star rollers 15. This can be made for a certain time duration or as long as the sensor 16 is actuated again.

A flouring device 17 covers the dough with flour within the chamber 9 by means of a dosing brush 18 and a distribution brush 19.

The dough 10 pressed into the receiving openings 4 is sheared off by means of a shearing edge 21 when the drum 2 is rotated again in direction of the arrow 20, whereby the real portioning is made. The dough pieces disposed within the receiving openings 4 reach a kneading location 22 after a rotation of the drum 2 for 90°, which kneading location is disposed in the region of the upper summit of the drum. There, a kneading device 23 is mounted on the framework 1 and is driven by a motor 24 via a V-belt drive 25 and comprises a kneading tool 26 in form of a plate that exerts a circular movement relative to the neighboring receiving openings 4 during the kneading process and is provided on its side facing the drum 2 with a stepwisely shaped recess 27 per receiving opening 4. The circular movement of the kneading tool 26 is obtained by an eccentric connection 28 between the plate 26 and the shaft 29 driven by the V-belt drive 25. The eccentricity of this connection 28 is suitably adjustable in order to make the radius of the circular movement of the kneading tool 26 adjustable, also during operation.

The completely kneaded dough pieces 30 are ejected from the receiving openings 4 at a deposition location 31 and are laid down on a conveyor belt 32 guided around a deflection roller 33 disposed near the drum 2, and the dough pieces 30 are conveyed off in direction of the arrow 34. The said ejection is created by a radial outward movement of a piston 35 guided in each receiving opening 4. Each piston 35 is guided by a linkage means 36 along a curved path 37 of a restricted guidance 38 so that a relative rotation of this restricted guidance 38 with respect to the drum 2 has at its consequence that the piston 35 in its receiving opening 4 is radially moved, either inwardly or outwardly. This relative rotation is created by a drive means 39 (FIGS. 2, 3) nearer described later on. Substantially, this curved path 37 is so shaped that the relative rotation of the curved path 37 that takes place during the intervals of movements of stepwise drum motion, causes a retraction of the pistons 35 at the portioning location 6, in order to create a suction effect onto the dough to be pressed in into the receiving openings 4. At the kneading location 22 a further retraction of the respective piston 25 takes place in the course of the kneading process, in order to give more space to the dough piece that during the kneading process receives by and by a ball-like shape. At the deposition location 31, however, the pistons 35 are moved as far outwardly that the outer front surface of each piston flushes with the circumferential surface of the drum, so that the dough pieces 30 are reliably transferred from the receiving openings 4 onto the conveyor belt 32.

The stepwise movement of the drum 2 is, as well as the motion of the drive means 39 for the relative rotation of the restricted guidance 38, are derived from the main drive means. For this, the main motor 40 (FIG. 1) drives a main drive shaft 41 (FIGS. 1, 3), on which a crank arm 42 for driving the drum is positioned that is articulately connected by a connection piece 43 to an oscillating crank 44 on which a ratchet 45 is articulated that cooperates with a ratchet wheel 46. Therefore, when the oscillating crank 44 is turned by the connection piece 43 for 90° in direction of the arrow 47 into the end position shown in FIG. 3, the ratchet wheel 46 is taken along by the ratchet 45 during this 90° swivel and is correspondingly rotated. The ratchet wheel 46 is secured to a hollow shaft 48 (FIG. 2) bearingly supported for rotation in the framework 1 by means of roller bearings 49. The hollow shaft 48 carries a flange 50 to which the drum 2 is secured.

The oscillating crank constitutes also a member of the drive means 39 for the relative rotation of the restricted guidance 38. For this, a tube forming a hollow shaft 51 is rigidly connected to the oscillating crank 44 and intersects the hollow shaft 48 and is bearingly supported within this. At its other end, the hollow shaft 51 carries a member 52 formed by a disk, that fits into the receiving flange 50 and carries the restricted guidance 38 for the pistons 35. The curved path 37 of the restricted guidance 38 is, on the one hand, disposed on this member 52, on the other hand on a member 53 adjustable with respect to the member 52 and constituted by a segment carried by the member 52, however linearly adjustable relative to it. The disk shaped member 52 and the separate segment shaped member 53 are nearer shown in FIGS. 4 and 5 in a position separated from each other, whereas the FIGS. 6 to 9 show these members 52, 53 in their cooperating position, however in different positions of operation. As FIG. 4 shows, the member 53 carries two parallel side surfaces 54 guided along linear, also parallel extending guides 55 of the basic body 56 of the member 52. Thereby, the two members 52, 53 are guided along each other for adjustment relative to each other. This adjustment is made by means of a toothed rod 57 carried by the member 53 and meshing with a pinion 58, positioned on a shaft 59 intersecting the tube-shaped hollow shaft 51 and carrying on its other end a worm wheel 60 meshing with a worm 61 positioned on a shaft 62 that can be rotated by a servo motor 63. The shaft 62 is bearingly supported within a housing 65 by means of roller bearings 64, which housing carries also the servo motor 63 and is connected to the oscillating crank 44. The shaft 62 intersects the housing 65 and is on its end opposite the servo motor 63 provided with a hand wheel 66 by which the shaft 62 can be rotated also by hand, independently from the servo motor 63. As it can be seen, a rotation of the shaft 62, may it be by hand or by the servo motor 63, causes via the pinion 58 and the toothed rod 57 a change of the relative position of the member 53 on the disk 52. Thereby, also the section of the curved path 37 carried by the member 53 is adjusted. This adjustment takes place independently from and in addition to the common rotation of the two members 52, 53 which takes place by the main motor 40 via the main drive shaft 41, the crank arm 42, the connection piece 43, the oscillating crank 44 and the hollow shaft 51. Whereas the drum 2 during the rotational motion of the main drive shaft 41 in direction of the arrow 67 only during the 90°-swivel of the oscillating crank 44 in direction of the arrow 47 is always rotated for a step (90°), the oscillation crank 44 participates completely in the advance and retracting motion of the connection piece 43, so that the oscillating crank for each turn of the main drive shaft 41 is first swiveled counter-clockwisely (FIG. 3) in direction of the arrow 47 and then back for also 90°. Therefore, during the swivel in counter-clockwise sense, the oscillating crank 44 participates in the rotation of the drum 2 for a step (90°). During the phases of stillstand of the drum 2 the oscillating crank 44 is swiveled back again and therewith causes via the hollow shaft 51 a rotation of the member 52 and of the member 53 carried by it relative to the drum. Since the several positions of the curved path 37 of the restricted guidance 38 for the pistons 35 are differently spaced apart from the axis of rotation of the drum 2, this rotation of the curved path 37 relative to the drum 2 causes the said advance or, respectively, retracted motion of the pistons 35 in the receiving openings 4, because each piston 35 is securely guided in the restricted guidance 38 by guide rollers 68 (FIG. 1) disposed on its linkage means 36. In order to avoid that the guide rollers 68 can escape from the restricted guidance 38 when the member 53 is adjusted relative to the member 52, prolongations 69 of the inner walls of the curved path are provided insidely on the two members 52, 53 and face the guides 55 so that also in the mostly detached position of the two members 52, 53 always a secure guidance for the guide rollers 68 of the pistons 35 is secured in all rotation positions of the curved path 37 (see also FIGS. 6, 7).

The curved path 37 is so formed that, when the restricted guidance 38 is rotated back (with respect to the drum 2), there results at the portioning location 6 (FIG. 1) a retraction of the pistons 35 in the receiving openings 4, in order to assist insertion of the dough into the receiving openings 4 by intake suction. Also at the kneading location 22 there is a retraction of the pistons 35 in order to give sufficient space for the dough piece that by the kneading operation by and by receives a ball-like shape. To the contrary, at the deposition location 31 the already mentioned outward movement of the pistons 35 takes place for ejection of the dough pieces off the receiving openings 4. In addition to these movements it is possible by the adjustment possibility of the two members 52, 53 constituting the restricted guidance 38 to exactly adjust the kneading pressure exerted during the kneading process on the dough piece, or, respectively, to vary the speed with which the piston 35 is retracted in the receiving opening 4, that means to vary the steepness of the lowering curve. Also it is possible to begin with a rise of the pistons 35 in the receiving openings 4 in the region of the kneading location 22 (so-called “piston lift”) in order to press dough pieces against the kneading tool 26. This piston lift can be made already before the respective receiving opening 4 has reached the kneading location 22.

The moments at which—in addition to rotating the restricted guidance 38 by means of the main driving shaft 41—an automatic adjustment of the members 52, 53 of the restricted guidance 38 takes place, or, respectively, the amount of this adjustment can be varied in a simple manner. For this, a counting disk 70 is positioned on the main drive shaft 41 which creates pulses in an end switch 72 by means of tooth-like projections 71 on its periphery, the end switch being connected by a line 73 to an adjustable control means 74 (FIG. 2) by which the aforesaid variations of the moments and angles of rotation of the shaft 59 and therewith of the adjustment of the members 52, 53 carrying the restricted guidance 38 can be adjusted. The control means 74 feeds the servo motor 63 correspondingly. The change of direction of rotation of the servo motor 63 can easily be performed, for example when a certain number of pulses created by the counting disk 70 has been reached. Since a complete rotation of the counting disk 70 for 360° corresponds to a to and fro swivel of the oscillation crank 44 and therefrom the to-swivel is used for the drum advance, about 180° of the rotation of the counting disk 77 can be used for varying conditions of the kneading operation. As already mentioned, an outward motion of the pistons 35 (piston lift) can take place already before reaching the kneading location 22, and this by a corresponding outward movement of the curved path 37 on the displaceable member 53.

In the FIGS. 6 and 7 extreme positions of the two members 52, 53 carrying the restricted guidance 38 are shown. According to FIG. 6, the two members 52 are most detached, according to FIG. 7 they are shown in a most approached position. Suitably, the relative position of the two members 52, 53 is so controlled by corresponding controlling of the servo motor 63 that a piston lift takes place before the kneading location 22 is reached. As soon the kneading location 22 is reached, a retracting motion of the pistons 35 in the receiving openings 4 takes place, corresponding to the kneading pressure exerted by the kneading means 23. This retraction takes place during the stillstand of the drum and, therefore, can be performed by a corresponding shape of the curved path 37 and/or by an inward motion of the adjustable member 53. The outward motion of the pistons 35 required at the deposition location 31 suitably is performed by a corresponding shape of the curved path 37 alone.

An additional control possibility for the relative adjustment of the member 53 with respect to the disk 52 consists in controlling the revolution speed of the servo motor. This, in particular, is of importance at the transition from the portioning location 6 to the kneading location 22, because during this transition the entire restricted guidance 38 rotates together with the drum 2 and, therefore, one is dependent during this transition only to the relative adjustment of the member 53 with respect to the member 52.

The described construction, however, has also the advantage that one can better adapt to different weights (volumina) of the dough pieces pressed into the receiving openings 4 at the portioning location 6. First, an adjustment of the take-up volume of the receiving openings 4 at the portioning location 6 is possible by rotating the worm wheel 60 by means of the hand wheel 66 and the worm 61, what has as a consequence a corresponding change of the relative position of the member 53 carrying the adjustable curved path section relative to the other member 52. Since that section of the curved path 37 which is disposed at the adjustable member 53, is associated at least to the conditions when kneading, an adaptation of the kneading conditions to the respective desired dough piece size can be obtained by a corresponding outward or, respectively, inward motion of the member 53 with respect to the axis of the shaft 59. With this, FIG. 6 shows the conditions at a minimum weight of the dough portion to be kneaded, FIG. 7 at a maximum weight thereof. Of course, however, it is also possible to adapt to different dough voluminas to be kneaded only by corresponding automatic adjustment of the adjustable member 53 by means of the servo motor 63, so that the described pre-adjustment via the hand wheel 66 can be dropped.

FIG. 8 shows that also at the portioning location 6 the conditions with respect to the effective take-up volume of the receiving openings 4 can be varied if the pinion 58 is rotated by the servo motor 63 and thereby the toothed rod 57 is shifted in direction of the double arrow 75, what causes an outward or inward motion of the piston 35 in dependence from the direction of this shift.

FIG. 8 shows also that the kneading means 23 at the kneading location 22 can be mounted swivelably in direction of the double arrow 76, for example by articulating the motor 24 and the entire kneading means 23 at the framework 1 around an axis 77 (FIG. 1). If the kneading means 23 is swiveled up, it is ensured that also such a dough piece can be conveyed under the kneading means 23 when the drum is advanced without any problem which dough piece with its surface produces beyond the periphery of drum 2 due to a piston lift. In FIG. 9 it is shown that the kneading means 23 has been lowered towards the receiving opening 4 for obtaining the necessary kneading pressure. The piston 35 positioned at the kneading location 22 is in the extremely advanced position, therefore, corresponding to a small dough portion and a high kneeding pressure.

The motion of the slide 7 is also derived from the main drive shaft 41 (FIG. 3). For this, the crank arm 42 is connected via the crank mechanism 11 with the pressing-in means 8 which on its part is inserted with its upper end into a recess 78 of the slide 7 and protrudes through an opening 79 of the bottom 80 of the chamber 9.

1. Apparatus for portioning and kneading of dough, comprising a drum (2) that is stepwisely rotatable by a main drive means (5) around a horizontal axis (3) within a framework (1), which drum is provided on its periphery with receiving openings (4) for the dough portions to be kneaded, which dough portions are introduced into the receiving openings (4) by a pressing-in means (8) at a portioning location (6) of the periphery of the drum, and comprising a kneading means (23) disposed at a kneading location (22) that is staggered with respect to the portioning location (6) in peripheral direction of the drum (2), wherein within each receiving opening (4) a piston (35) is displaceable in radial direction of the drum (2) by means of a curved restricted guidance (38) that is rotatable relative to the drum (2) by a drive means (39) at least in the phases of stillstand of the drum (2) and has two members (52, 53) which are displaceable relative to each other, characterized in that the two members (52, 53) are motor-driven adjustable relative to each other by a further drive means (63) independently from the rotation of the restricted guidance (38) at least during the kneading action so that at least during the kneading action a displacement of each piston (35) positioned at the kneading location (22) takes place in radial direction of the drum (2).

2. Apparatus according to claim 1, characterized in that the further drive means comprises a servo motor (63) controlled by a counting wheel (70) rotated by the main drive means (5).

3. Apparatus according to claim 1 or 2, characterized in that the two members (52, 53) are linearly adjustable relative to each other, whereby one member (53) is guided within a linear guide (55) of the other member (52).

4. Apparatus according to claim 3, characterized in that the one member (52) is rigidly connected to a hollow shaft (51) serving for rotation of the restricted guidance (38), whereas the other member (53) carries a toothed rod (57) meshing with a pinion (58) disposed on a shaft (59) bearingly supported within the hollow shaft (51) and rotatable by the further drive means (63).

5. Apparatus according to claim 4, characterized in that the shaft (59) carries a worm wheel (60) that meshes with a worm (61) rotatable by the further drive means (63).

6. Apparatus according to any of claims 1 to 5, characterized in that the two members (52, 53) are so adjustable by the further drive means (63) already before the start of the kneading action, that the pistons (35) are moved outwardly.

7. Apparatus according to any of claims 1 to 6, characterized in that the servo motor (63) of the further drive means is carried by an oscillating crank (44) by which the stepwise advance of the drum (2) and the rotation of the restricted guidance (38) relative to the drum (2) are performed.

8. Apparatus according to claims 5 and 7, characterized in that the oscillating crank (44) carries a housing (65) in which the driven shaft (62) of the servo motor (63) is bearingly supported, whereby this driven shaft (62) carries the worm (61) meshing with the worm wheel (60) that is also disposed within the housing (65).

9. Apparatus according to claim 8, characterized in that the shaft (62) intersects the housing (65) and carries on its end protruding out of the housing a hand wheel (66) for adjustment of the restricted guidance (38) by hand.
